(19) United States
(12) Patent Application Publication
(10) Pub. No.: US 2026/0010094 A1
(43) Pub. Date: Jan. 8, 2026

(54) LIGHT EMITTING DEVICE, EXPOSING DEVICE, AND IMAGE FORMING APPARATUS

(71) Applicant: FUJIFILM Business Innovation Corp., Tokyo (JP)

(72) Inventor: Yusuke NIISAKA, Kanagawa (JP)

(73) Assignee: FUJIFILM Business Innovation Corp., Tokyo (JP)

(21) Appl. No.: 19/038,894

(22) Filed: Jan. 28, 2025

(30) Foreign Application Priority Data
Jul. 4, 2024 (JP) 2024-108363

(51) Int. Cl. G03G 15/041; B41J 2/45; B41J 2/47; G03G 15/04

(52) U.S. Cl. CPC G03G 15/0415; B41J 2/45; B41J 2/47; G03G 15/04036

(57) ABSTRACT

A light emitting device includes: plural resistance elements having different resistance values; plural light emitting elements including anode terminals to which a reference potential is applied, and cathode terminals connected to first ends of the plural resistance elements in common; a turn-on instructor configured to sequentially output turn-on instruction signals to the plural light emitting elements to sequentially turn ON the plural light emitting elements; a turn-on potential applier configured to apply a turn-on potential for turning ON the plural light emitting elements; and a switching circuit configured to switch connection states between second ends of the plural resistance elements and the turn-on potential applier.

### CROSS-REFERENCE TO RELATED APPLICATIONS

This application is based on and claims priority under 35 USC 119 from Japanese Patent Application No. 2024-108363 filed Jul. 4, 2024.

### BACKGROUND

### (i) Technical Field

The present disclosure relates to a light emitting device, an exposing device, and an image forming apparatus.

### (ii) Related Art

Japanese Unexamined Patent Application Publication No. 2003-136778 discloses a light intensity correction method for a light emitting element array. In this method, a resistor short-circuit wire is burned out with a laser beam to adjust the resistance value so that the variation in chip light intensity falls within a predetermined range.

Japanese Unexamined Patent Application Publication No. 2003-320700 discloses a light emitting element array chip in which a plurality of 1-bit memory elements electrically writable and erasable from the outside is provided to a self-scanning light emitting element array to adjust average light output.

Japanese Unexamined Patent Application Publication No. 2018-030336 discloses an exposing device in which, when sequentially performing turn-on control for a plurality of light emitting elements, a voltage to be applied to the light emitting elements is selected from two types of voltage and the ON period of the light emitting elements are changed to adjust the light exposure amount.

### SUMMARY

An electrophotographic image forming apparatus such as a printer, a copying machine, or a facsimile machine uses a recording device including, as an exposing device, an LED print head (LPH) including a light emitting element array in which a plurality of light emitting diodes (LEDs) serving as light emitting elements is arrayed in a main scanning direction to meet a demand for downsizing of the apparatus. A light emitting chip including a self-scanning light emitting element array (SLED) in which a plurality of light emitting elements is arrayed on a substrate and controlled to be sequentially turned ON uses light emitting thyristors as the light emitting elements.

In the image forming apparatus in which an image carrier such as a photoreceptor drum is exposed to light using the LED print head, the light exposure amount may be adjusted by adjusting an application voltage to be applied to the light emitting thyristors or adjusting a light exposure period. However, the light exposure period needs to be reduced along with an increase in the image formation speed, and the adjustable range of the light exposure period is limited. Further, the adjustable range of the application voltage is limited to properly perform ON/OFF control for the light emitting thyristors. Therefore, there is a demand to adjust the emitted light intensity of each light emitting thyristor without changing the voltage to be applied to the light emitting thyristor.

Aspects of non-limiting embodiments of the present disclosure therefore relate to a light emitting device, an exposing device, and an image forming apparatus in which, when sequentially turning ON a plurality of light emitting elements, the emitted light intensity of each light emitting element may be adjusted without changing the voltage to be applied to the light emitting element.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a light emitting device comprising: a plurality of resistance elements having different resistance values; a plurality of light emitting elements including anode terminals to which a reference potential is applied, and cathode terminals connected to first ends of the plurality of resistance elements in common; a turn-on instructor configured to sequentially output turn-on instruction signals to the plurality of light emitting elements to sequentially turn ON the plurality of light emitting elements; a turn-on potential applier configured to apply a turn-on potential for turning ON the plurality of light emitting elements; and a switching circuit configured to switch connection states between second ends of the plurality of resistance elements and the turn-on potential applier.

### BRIEF DESCRIPTION OF THE DRAWINGS

Exemplary embodiments of the present disclosure will be described in detail based on the following figures, wherein:

FIG. 1 illustrates the configuration of an image forming apparatus of an exemplary embodiment of the present disclosure;

FIG. 2 illustrates the configuration of a print head illustrated in FIG. 1;

FIG. 3 illustrates the configuration of a light emitting device illustrated in FIG. 2;

FIG. 4 illustrates the circuit configuration of a light emitting chip;

FIG. 5 conceptually illustrates a light exposure amount of the print head;

FIGS. 6A and 6B illustrate how the light exposure amount is adjusted within a range of a period per line before and after the speed is increased;

FIG. 7 illustrates the configuration of the light emitting device of the exemplary embodiment of the present disclosure;

FIG. 8 illustrates a switching control table that is an example of association information to be referenced by a light intensity controller;

FIGS. 9A and 9B illustrate expressions for calculating a resistance value of a combined resistance of resistance elements connected between a turn-on potential applier and a cathode terminal of a light emitting thyristor;

FIG. 10 illustrates the configuration of a light emitting chip of another exemplary embodiment of the present disclosure; and

FIG. 11 illustrates the configuration of a light emitting chip of another exemplary embodiment of the present disclosure.

### DETAILED DESCRIPTION

Exemplary embodiments of the present disclosure are described in detail with reference to the drawings.

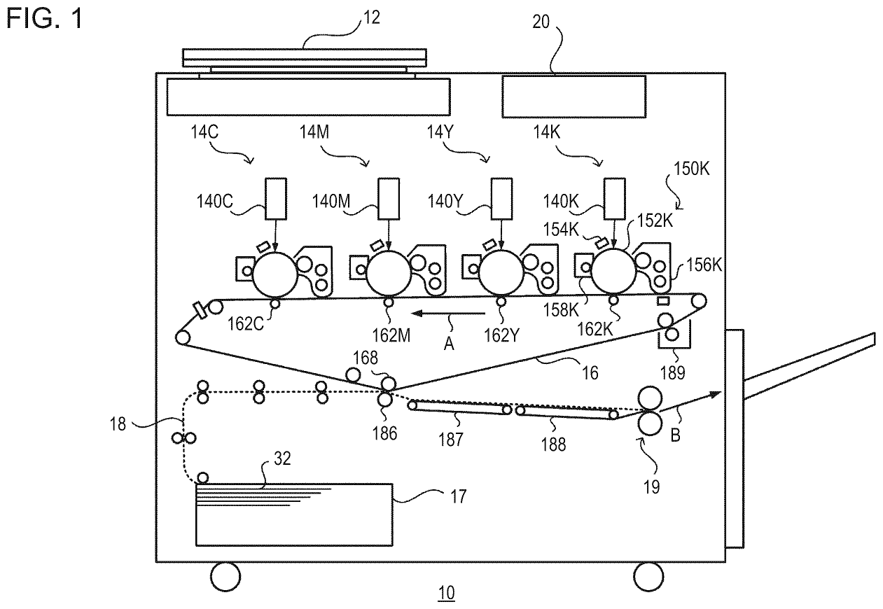

FIG. 1 illustrates the configuration of an image forming apparatus 10 of an exemplary embodiment of the present disclosure.

As illustrated in FIG. 1, the image forming apparatus 10 includes an image reading device 12, image forming units 14, an intermediate transfer belt 16, a paper tray 17, a sheet transport path 18, a fixing device 19, and a controller 20. The image forming apparatus 10 is a multifunction peripheral having a function of a printer that prints image data received from a personal computer (not illustrated) etc., a function of a full-color copying machine using the image reading device 12, and a function of a facsimile machine.

An overview of the image forming apparatus 10 is described. The image reading device 12 and the controller 20 are disposed at an upper part of the image forming apparatus 10. The image reading device 12 reads a document image and outputs the document image to the controller 20. The controller 20 performs image processing such as gray-level correction and resolution correction on image data input from the image reading device 12 or image data input from a personal computer (not illustrated) etc. via a network such as a LAN, and controls operations of the image forming units 14 to generate an image based on the image data.

Four image forming units 14 are disposed below the image reading device 12 in conjunction with colors of color images. In this exemplary embodiment, four image forming units 14K, 14Y, 14M, and 14C are horizontally arrayed with predetermined intervals along the intermediate transfer belt 16 in conjunction with black (K), yellow (Y), magenta (M), and cyan (C), respectively. The intermediate transfer belt 16 rotates in a direction of an arrow A in FIG. 1 as an intermediate transfer body. The four image forming units 14K, 14Y, 14M, and 14C sequentially form color toner images based on image data input from the controller 20. The plurality of toner images is transferred onto the intermediate transfer belt 16 (first transfer) at timings at which they are laid one on top of another. The order of colors of the image forming units 14K, 14Y, 14M, and 14C is not limited to “black (K), yellow (Y), magenta (M), cyan (C)” and may be any order such as “yellow (Y), magenta (M), cyan (C), black (K).”

The sheet transport path 18 is disposed below the intermediate transfer belt 16. Recording paper 32 fed from the paper tray 17 is transported along the sheet transport path 18. The color toner images transferred onto the intermediate transfer belt 16 in multiple layers are collectively transferred onto the recording paper 32 (second transfer). The transferred toner images are fixed by the fixing device 19 and the recording paper 32 is output to the outside along an arrow B.

Each component of the image forming apparatus 10 is described in more detail.

The image forming units 14K, 14Y, 14M, and 14C (image formers) are disposed parallel to each other with predetermined intervals in the horizontal direction, and have substantially the same configurations except that the colors of images to be formed are different. The image forming unit 14K is described hereinafter. The components of the image forming units 14 are distinguished by a suffix K, Y, M, or C.

The image forming unit 14K includes a print head 140K that forms an electrostatic latent image by performing a light exposure process based on image data input from the controller 20, and an image forming device 150K on which the electrostatic latent image is formed by the print head 140K.

The print head 140K is an exposing device in which a plurality of light emitting elements such as light emitting diodes (LEDs) or light emitting thyristors is arrayed and the light emitting element corresponding to each pixel of image data from the controller 20 is controlled to be turned ON or OFF to expose a photoreceptor drum 152K to light. The print head 140K includes a light exposure amount controller that controls a light exposure amount for the photoreceptor drum 152 that is an image carrier by controlling the ON period and the emitted light intensity of the plurality of light emitting elements when forming an electrostatic latent image by controlling the light intensity of light to be emitted from a light emitting device 50 and exposing the photoreceptor drum 152 to light.

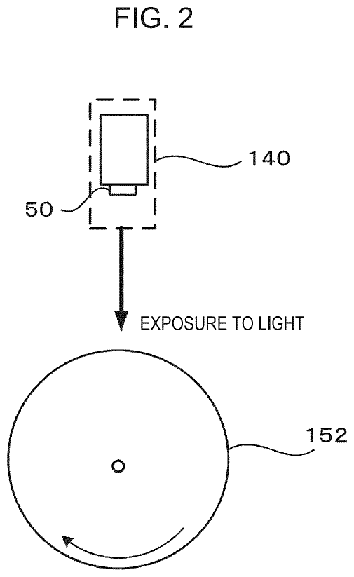

The image forming device 150K includes the photoreceptor drum 152K, a charging device 154K, a developing device 156K, and a cleaning device 158K. The photoreceptor drum 152K is an image carrier that rotates at a predetermined rotational speed along a direction of an arrow in FIG. 2. The charging device 154K uniformly charges the surface of the photoreceptor drum 152K. The developing device 156K develops an electrostatic latent image formed on the photoreceptor drum 152K by light exposure from the exposing device. The photoreceptor drum 152K is uniformly charged by the charging device 154K, and an electrostatic latent image is formed on the photoreceptor drum 152K with light radiated from the print head 140K of the exposing device. The electrostatic latent image formed on the photoreceptor drum 152K is developed with black (K) toner by the developing device 156K, and the toner image is transferred onto the intermediate transfer belt 16. After the toner image is transferred, residual toner, paper dust, etc. adhering to the photoreceptor drum 152K are removed by the cleaning device 158K.

The other image forming units 14Y, 14M, and 14C form yellow (Y), magenta (M), and cyan (C) toner images and transfer the formed color toner images onto the intermediate transfer belt 16 similarly to the above.

On the intermediate transfer belt 16, first transfer rollers 162K, 162Y, 162M, and 162C are disposed to face the image forming units 14K, 14Y, 14M, and 14C, respectively. The color toner images formed on the photoreceptor drums 152K, 152Y, 152M, and 152C are transferred onto the intermediate transfer belt 16 in multiple layers by the first transfer rollers 162. Residual toner adhering to the intermediate transfer belt 16 is removed by a cleaning blade or brush of a belt cleaning device 189 provided downstream of a second transfer position.

At a second transfer position on the sheet transport path 18, a second transfer roller 186 is disposed in press contact with a backup roller 168. The color toner images transferred onto the intermediate transfer belt 16 in multiple layers are secondly transferred onto the recording paper 32 by a press contact force and an electrostatic force of the second transfer roller 186. The recording paper 32 onto which the color toner images are transferred is transported to the fixing device 19 by a transport belt 187 and a transport belt 188.

The fixing device 19 heats and pressurizes the recording paper 32 onto which the color toner images are transferred to melt the toner and fix it to the recording paper 32.

As described above, the intermediate transfer belt 16, the first transfer rollers 162, the second transfer roller 186, the transport belts 187 and 188, the fixing device 19, and other components function as a transferrer that transfers the images developed on the photoreceptor drums 152 by the developing devices 156 onto the recording paper 32 that is a recording medium.

The configuration of each of the print heads 140K, 140Y, 140M, and 140C (hereinafter represented simply by “140”) of the image forming apparatus 10 illustrated in FIG. 1 is described.

As illustrated in FIG. 2, the print head 140 includes the light emitting device 50 including an array of light emitting elements, and performs a light exposure process by irradiating the rotating photoreceptor drum 152 with light based on image data.

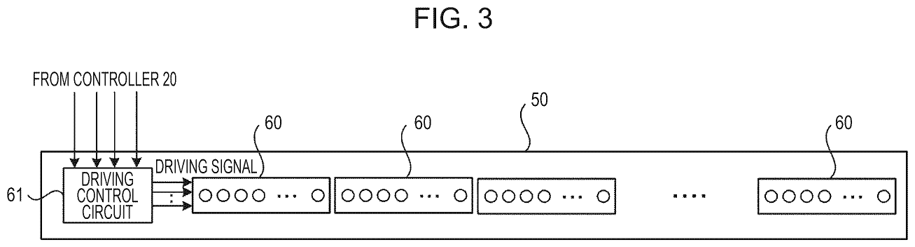

The configuration of the light emitting device 50 illustrated in FIG. 2 is described with reference to FIG. 3. As illustrated in FIG. 3, the light emitting device 50 includes a plurality of light emitting chips 60 each including a plurality of light emitting elements, and a driving control circuit 61 that outputs driving signals to the light emitting chips 60.

The driving control circuit 61 receives signals from the controller 20 and outputs various driving signals to control the light emitting elements of the light emitting chips 60 to be turned ON.

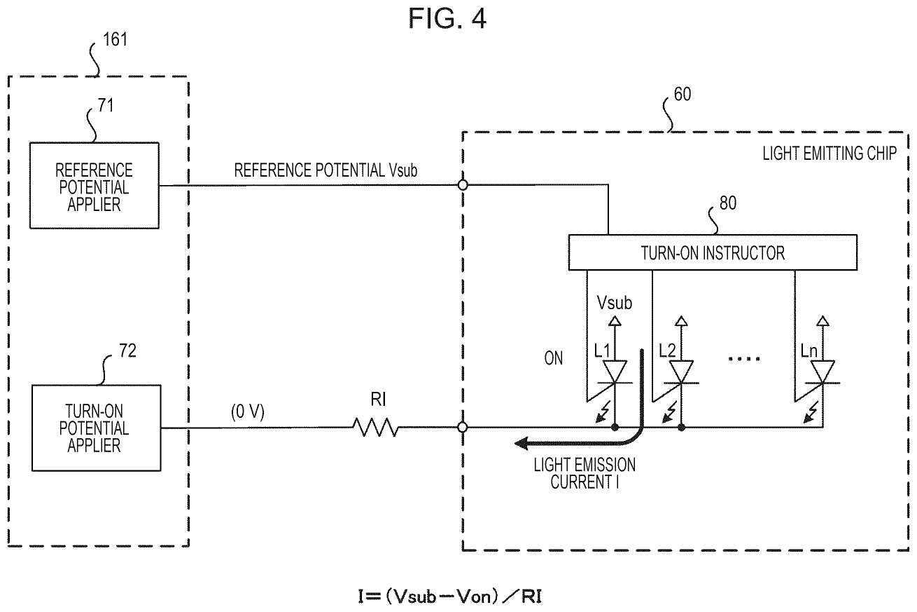

FIG. 4 illustrates the circuit configuration of each light emitting chip 60. As illustrated in FIG. 4, the light emitting chip 60 includes a turn-on instructor 80 and a plurality of light emitting thyristors L1 to Ln. In the light emitting chip 60 of this exemplary embodiment, the n light emitting thyristors (light emitting elements) L1 to Ln are sequentially turned ON to radiate light, thereby exposing the photoreceptor drum 152 to light. The term “light emitting thyristor L” means each of the plurality of light emitting thyristors L1 to Ln without distinction.

The light emitting thyristors L are light emitting elements in which a reference potential Vsub is applied to anode terminals and cathode terminals are connected to a first end of a current limiting resistor RI in common. The turn-on instructor 80 sequentially outputs turn-on instruction signals to the plurality of light emitting thyristors L to sequentially turn ON the plurality of light emitting thyristors L.

Prior to description about the configuration of the driving control circuit 61 for driving the light emitting chip 60, description is made about an operation of a driving control circuit 161 of a comparative example to which the technology of the exemplary embodiment of the present disclosure is not applied.

As illustrated in FIG. 4, the driving control circuit 161 of the comparative example includes a reference potential applier 71 and a turn-on potential applier 72.

The reference potential applier 71 applies the reference potential Vsub to the light emitting chip 60. The turn-on potential applier 72 applies a turn-on potential to the cathode terminals of the plurality of light emitting thyristors L via the current limiting resistor RI. In FIG. 4, a turn-on potential of 0 V is applied to the first end of the current limiting resistor RI.

Although illustration is omitted in FIG. 4, the light emitting chip 60 includes a turn-off element such as a turn-off thyristor for turning OFF the light emitting thyristors L in the ON state. The driving control circuit 161 outputs a turn-off signal to the turn-off element to sequentially turn OFF the light emitting thyristors L in the ON state.

Since the turn-on potential is 0 V in the comparative example described above, a light emission current I that flows through the light emitting thyristor L in the ON state may be calculated from the following expression assuming that the ON voltage of the light emitting thyristor L is represented by Von.

$$Light emission current I = ( reference potential Vsub - Von ) / RI$$

That is, when the reference potential Vsub, the turn-on potential, and the current limiting resistor RI exhibit fixed values, the light emission current I that flows when the light emitting thyristor L is turned ON is fixed to a constant value. That is, the light intensity of the light emitting thyristor L is fixed.

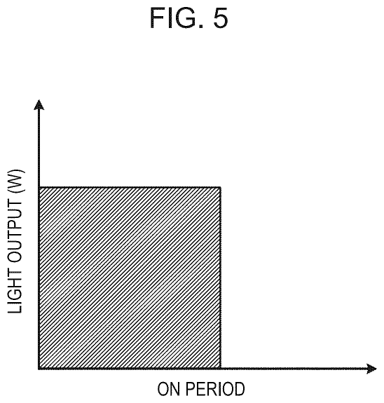

In the print head 140 including the light emitting device 50 including the light emitting chips 60, however, there is a demand to adjust the light exposure amount by changing the light intensity. FIG. 5 conceptually illustrates the light exposure amount of the print head 40. The light exposure amount is determined by the product of light output and an ON period in the light emission of the light emitting thyristor L. That is, the light exposure amount increases as the area of a hatched portion in FIG. 5 increases. That is, the light exposure amount of the print head 40 may be adjusted by adjusting an application voltage to be applied to the light emitting thyristor L or adjusting a light emission period. However, the light emission period per line needs to be reduced along with an increase in the image formation speed, and the adjustable range of the light emission period is limited.

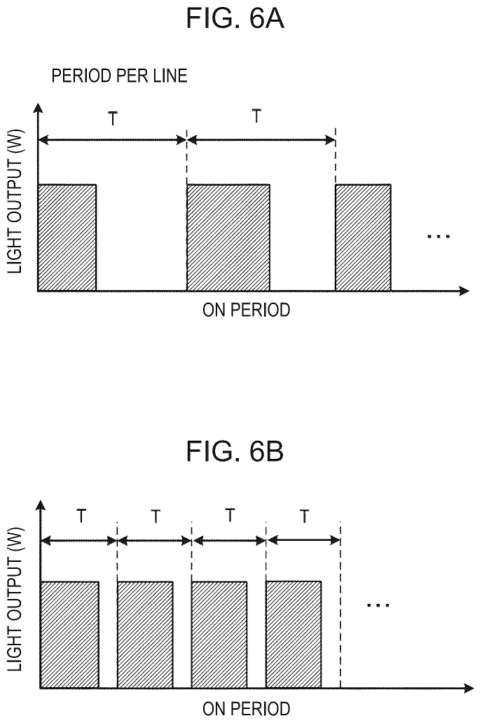

For example, FIGS. 6A and 6B illustrate how the light exposure amount is adjusted within a range of a period T per line before and after the speed is increased. FIG. 6A illustrates the state before the speed is increased, and the period T per line is long. Therefore, the light exposure amount may be adjusted by adjusting the light emission period within the range of the period T. In FIG. 6B after the speed is increased, however, the period T per line is short. Therefore, the adjustable range of the light exposure amount is limited even if the light emission period is adjusted within the range of the period T.

The light exposure amount may be adjusted by adjusting the application voltage to be applied to the light emitting thyristor L to adjust the light output in the light emission. Specifically, the light output of the light emitting thyristor L may be adjusted by changing the reference potential Vsub or the turn-on potential described above. When the reference potential Vsub or the turn-on potential is changed, however, a problem may arise in that the turn-on control and the turn-off control for the light emitting thyristor L are not properly performed. The adjustable range of the application voltage is also limited to properly perform the ON/OFF control for the light emitting thyristor L. As a result, there is a demand to adjust the emitted light intensity of the light emitting thyristor L without changing the voltage to be applied to the light emitting thyristor L.

In view of this, the light emitting device 50 of this exemplary embodiment has the following circuit configuration.

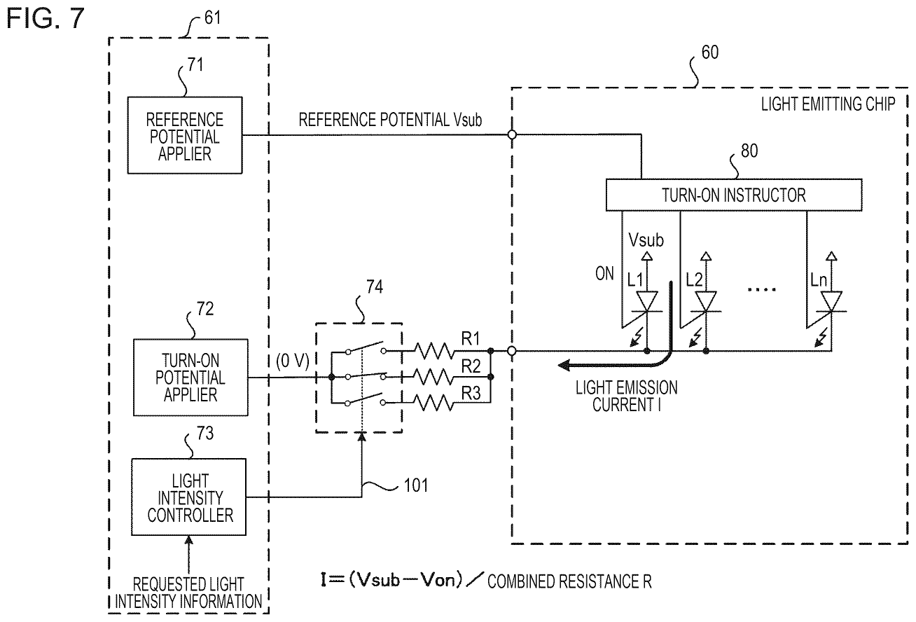

The configuration of the light emitting device 50 of this exemplary embodiment is described with reference to FIG. 7. Since the circuit configuration of the light emitting chip 60 in FIG. 7 has been described with reference to FIG. 4, detailed description thereof is omitted.

As illustrated in FIG. 7, the driving control circuit 61 of this exemplary embodiment includes the reference potential applier 71, the turn-on potential applier 72, and a light intensity controller 73. Since the reference potential applier 71 and the turn-on potential applier 72 in FIG. 7 are the same as those in FIG. 4, description thereof is omitted.

The light emitting device 50 of this exemplary embodiment includes three resistance elements R1 to R3 having different resistance values, and a switching circuit 74.

In the plurality of light emitting thyristors L in the light emitting chip 60, the reference potential Vsub is applied to the anode terminals, and the cathode terminals are connected to the first ends of the three resistance elements R1 to R3 in common. The switching circuit 74 is configured to switch the connection states between the second ends of the plurality of resistance elements R1 to R3 and the turn-on potential applier 72.

The switching circuit 74 has a circuit configuration in which the connection states between the three resistance elements R1 to R3 and the turn-on potential applier 72 are independently switchable in response to a switching control signal 101 from the light intensity controller 73. In FIG. 7, only the resistance element R2 is connected to the turn-on potential applier 72.

The light intensity controller 73 outputs, to the switching circuit 74, the switching control signal 101 for switching the connection states in the switching circuit 74 based on requested light intensity information indicating a requested emitted light intensity of the light emission of the plurality of light emitting thyristors L.

Specifically, the light intensity controller 73 outputs, to the switching circuit 74, the switching control signal 101 generated using association information indicating the requested emitted light intensity of the light emission of the plurality of light emitting thyristors L and indicating which of the three resistance elements R1 to R3 is to be connected between the turn-on potential applier 72 and the cathode terminals of the light emitting thyristors L to achieve the emitted light intensity.

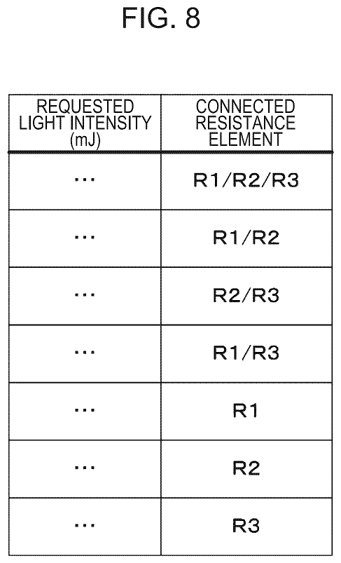

FIG. 8 illustrates a switching control table as an example of the association information. In the switching control table illustrated in FIG. 8, requested light intensities and connected resistance elements are associated with each other. The light intensity controller 73 selects, from the switching control table, an optimum combination of the resistance elements R1 to R3 to achieve the requested light intensity indicated by the requested light intensity information. The light intensity controller 73 outputs, to the switching circuit 74, the switching control signal 101 for achieving the selected combination of the resistance elements R1 to R3.

In the light emitting device 50 of this exemplary embodiment, the light emission current I that flows through the light emitting thyristor L1 may be calculated from the following expression.

$$Light emission current I = ( reference potential Vsub - Von ) / combined resistance R$$

The combined resistance R exhibits a combined resistance value of one or more resistance elements switched by the switching circuit 74 among the resistance elements R1 to R3.

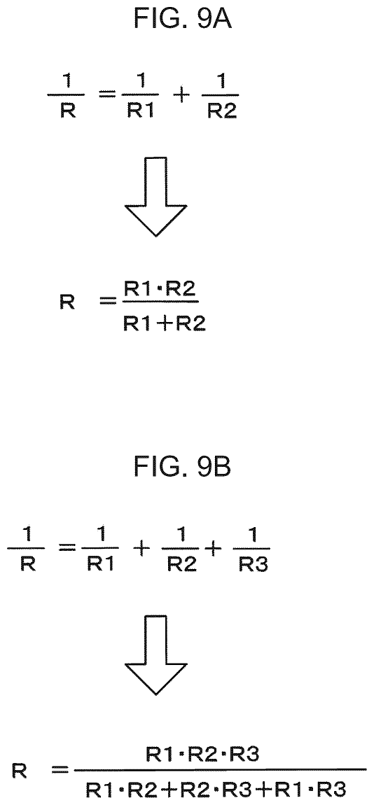

For example, when the resistance elements R1 and R2 are connected between the turn-on potential applier 72 and the cathode terminals of the light emitting thyristors L, the combined resistance R exhibits a value calculated from an expression illustrated in FIG. 9A. When the resistance elements R1, R2, and R3 are connected between the turn-on potential applier 72 and the cathode terminals of the light emitting thyristors L, the combined resistance R exhibits a value calculated from an expression illustrated in FIG. 9B. When only one of the resistance elements R1 to R3 is connected through the switching by the switching circuit 74, the combined resistance R exhibits the resistance value of the one selected resistance element.

In the light emitting device 50 of this exemplary embodiment, a combination of the resistance elements R1 to R3 that achieves the requested light intensity is selected, and the light emission current I flows through the light emitting thyristor L according to the combined resistance of the selected resistance elements.

In this exemplary embodiment, the switching states of the three resistance elements R1 to R3 are controlled, but the technology of the exemplary embodiment of the present disclosure is not limited to this case. The technology of the exemplary embodiment of the present disclosure is also applicable to a configuration in which two resistance elements are used or four or more resistance elements are used.

In FIG. 7, the plurality of light emitting thyristors L is provided inside the light emitting chip 60. The three resistance elements R1 to R3 are provided outside the light emitting chip 60. The first ends of the three resistance elements R1 to R3 are connected to the cathode terminals of the light emitting thyristors L in common.

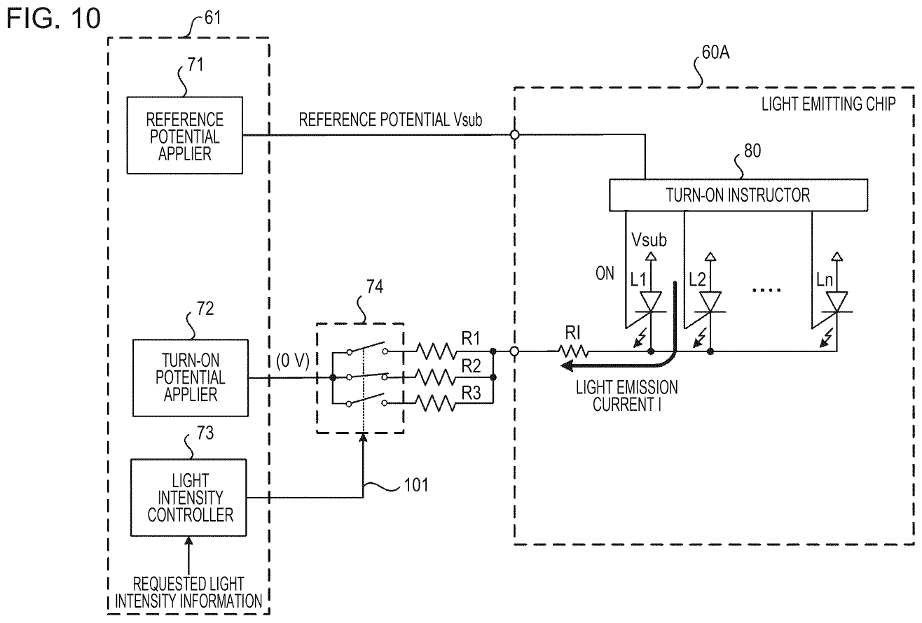

The current limiting resistor RI serving as an internal resistance element may be provided together with the light emitting thyristors L inside the light emitting chip. FIG. 10 illustrates a light emitting chip 60A having such a configuration. In FIG. 10, the current limiting resistor RI is provided inside the light emitting chip 60A. The current limiting resistor RI is connected between the cathode terminals of the plurality of light emitting thyristors L and the first ends of the three resistance elements R1 to R3. In the circuit configuration illustrated in FIG. 10, the light emission current I is determined according to a resistance value obtained by adding the resistance value of the combined resistance R of the resistance elements selected from among the three resistance elements R1 to R3 and the resistance value of the current limiting resistor RI serving as the internal resistance element.

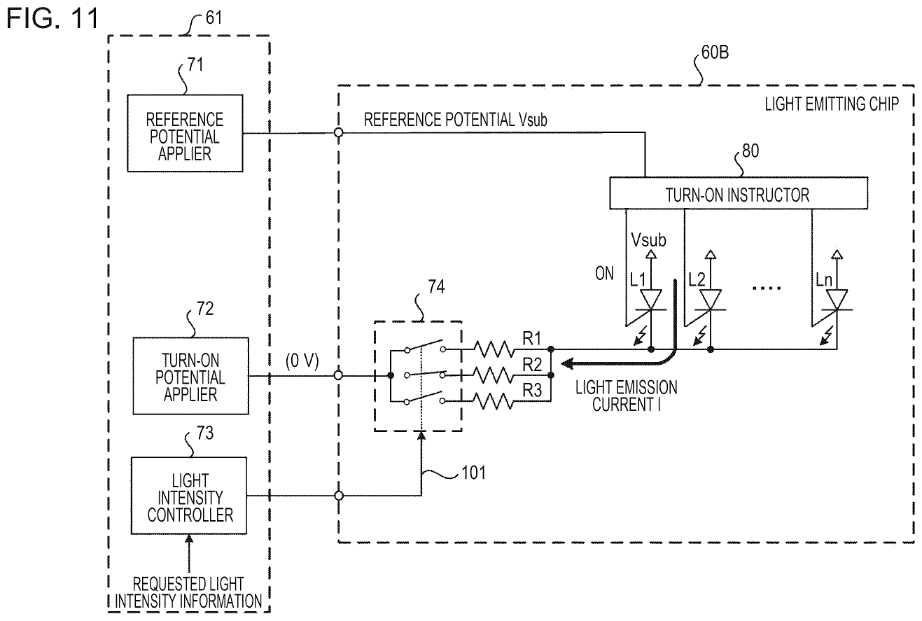

The circuit configuration may be such that the three resistance elements R1 to R3 are provided together with the plurality of light emitting thyristors L inside the light emitting chip instead of providing the current limiting resistor RI inside the light emitting chip. FIG. 11 illustrates a light emitting chip 60B having such a configuration. FIG. 11 illustrates a circuit configuration in which the switching circuit 74 and the three resistance elements R1 to R3 are provided inside the light emitting chip 60B.

By providing the switching circuit 74 and the three resistance elements R1 to R3 outside the light emitting chip 60 as illustrated in FIG. 7, the resistance values of the three resistance elements R1 to R3 may be changed without changing the light emitting chip 60. In this case, however, the circuit scale of the light emitting device 50 may increase. The circuit scale does not increase when the switching circuit 74 and the three resistance elements R1 to R3 are provided inside the light emitting chip 60B as illustrated in FIG. 11. In this case, however, the light emitting chip 60B needs to be changed when changing the resistance values of the three resistance elements R1 to R3.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A light emitting device comprising:
a plurality of resistance elements having different resistance values;
a plurality of light emitting elements including anode terminals to which a reference potential is applied, and cathode terminals connected to first ends of the plurality of resistance elements in common;
a turn-on instructor configured to sequentially output turn-on instruction signals to the plurality of light emitting elements to sequentially turn ON the plurality of light emitting elements;
a turn-on potential applier configured to apply a turn-on potential for turning ON the plurality of light emitting elements; and
a switching circuit configured to switch connection states between second ends of the plurality of resistance elements and the turn-on potential applier.
   (((2)))

The light emitting device according to (((1))), further comprising a light intensity controller configured to output, to the switching circuit, a switching control signal for switching the connection states in the switching circuit based on requested light intensity information indicating a requested emitted light intensity of light emission of the plurality of light emitting elements.

(((3)))

The light emitting device according to (((2))), wherein the light intensity controller is configured to output, to the switching circuit, the switching control signal for switching the connection states in the switching circuit using association information indicating the requested emitted light intensity of the light emission of the plurality of light emitting elements and indicating which of the plurality of resistance elements is to be connected between the turn-on potential applier and the cathode terminals of the light emitting elements to achieve the emitted light intensity.

(((4)))

The light emitting device according to any one of (((1))) to (((3))), wherein:
the plurality of light emitting elements is provided inside a light emitting chip, and
the plurality of resistance elements is provided together with the plurality of light emitting elements inside the light emitting chip.
   (((5)))

The light emitting device according to any one of (((1))) to (((3))), wherein:
the plurality of light emitting elements is provided inside a light emitting chip, and
the plurality of resistance elements is provided outside the light emitting chip.
   (((6)))

The light emitting device according to (((5))), wherein an internal resistance element is further provided between the cathode terminals of the plurality of light emitting elements and the first ends of the plurality of resistance elements.

(((7)))

An exposing device comprising:
a light emitting device including:
   a plurality of resistance elements having different resistance values;
   a plurality of light emitting elements including anode terminals to which a reference potential is applied, and cathode terminals connected to first ends of the plurality of resistance elements in common;
   a turn-on instructor configured to sequentially output turn-on instruction signals to the plurality of light emitting elements to sequentially turn ON the plurality of light emitting elements;
   a turn-on potential applier configured to apply a turn-on potential for turning ON the plurality of light emitting elements; and
   a switching circuit configured to switch connection states between second ends of the plurality of resistance elements and the turn-on potential applier; and
a light exposure amount controller configured to control a light exposure amount for an image carrier by controlling an ON period and an emitted light intensity of the plurality of light emitting elements when forming an electrostatic latent image by exposing the image carrier to light from the light emitting device.
   (((8)))

An image forming apparatus comprising:
an exposing device including:
   a light emitting device including:
      a plurality of resistance elements having different resistance values;
      a plurality of light emitting elements including anode terminals to which a reference potential is applied, and cathode terminals connected to first ends of the plurality of resistance elements in common;
      a turn-on instructor configured to sequentially output turn-on instruction signals to the plurality of light emitting elements to sequentially turn ON the plurality of light emitting elements;
      a turn-on potential applier configured to apply a turn-on potential for turning ON the plurality of light emitting elements; and
      a switching circuit configured to switch connection states between second ends of the plurality of resistance elements and the turn-on potential applier; and
   a light exposure amount controller configured to control a light exposure amount for an image carrier by controlling an ON period and an emitted light intensity of the plurality of light emitting elements when forming an electrostatic latent image by exposing the image carrier to light from the light emitting device;
a developing device configured to develop the electrostatic latent image on the image carrier that has been exposed to the light by the exposing device; and
a transferrer configured to transfer, onto a recording medium, an image on the image carrier that has been developed by the developing device.

What is claimed is:

1. A light emitting device comprising:
a plurality of resistance elements having different resistance values;
a plurality of light emitting elements including anode terminals to which a reference potential is applied, and cathode terminals connected to first ends of the plurality of resistance elements in common;
a turn-on instructor configured to sequentially output turn-on instruction signals to the plurality of light emitting elements to sequentially turn ON the plurality of light emitting elements;
a turn-on potential applier configured to apply a turn-on potential for turning ON the plurality of light emitting elements; and
a switching circuit configured to switch connection states between second ends of the plurality of resistance elements and the turn-on potential applier.

2. The light emitting device according to claim 1, further comprising a light intensity controller configured to output, to the switching circuit, a switching control signal for switching the connection states in the switching circuit based on requested light intensity information indicating a requested emitted light intensity of light emission of the plurality of light emitting elements.

3. The light emitting device according to claim 2, wherein the light intensity controller is configured to output, to the switching circuit, the switching control signal for switching the connection states in the switching circuit using association information indicating the requested emitted light intensity of the light emission of the plurality of light emitting elements and indicating which of the plurality of resistance elements is to be connected between the turn-on potential applier and the cathode terminals of the light emitting elements to achieve the emitted light intensity.

4. The light emitting device according to claim 1, wherein:
the plurality of light emitting elements is provided inside a light emitting chip, and
the plurality of resistance elements is provided together with the plurality of light emitting elements inside the light emitting chip.

5. The light emitting device according to claim 1, wherein:
the plurality of light emitting elements is provided inside a light emitting chip, and
the plurality of resistance elements is provided outside the light emitting chip.

6. The light emitting device according to claim 5, wherein an internal resistance element is further provided between the cathode terminals of the plurality of light emitting elements and the first ends of the plurality of resistance elements.

7. An exposing device comprising:
a light emitting device including:
a plurality of resistance elements having different resistance values;
a plurality of light emitting elements including anode terminals to which a reference potential is applied, and cathode terminals connected to first ends of the plurality of resistance elements in common;
a turn-on instructor configured to sequentially output turn-on instruction signals to the plurality of light emitting elements to sequentially turn ON the plurality of light emitting elements;
a turn-on potential applier configured to apply a turn-on potential for turning ON the plurality of light emitting elements; and
a switching circuit configured to switch connection states between second ends of the plurality of resistance elements and the turn-on potential applier; and
a light exposure amount controller configured to control a light exposure amount for an image carrier by controlling an ON period and an emitted light intensity of the plurality of light emitting elements when forming an electrostatic latent image by exposing the image carrier to light from the light emitting device.

8. An image forming apparatus comprising:
an exposing device including:
a light emitting device including:
a plurality of resistance elements having different resistance values;
a plurality of light emitting elements including anode terminals to which a reference potential is applied, and cathode terminals connected to first ends of the plurality of resistance elements in common;
a turn-on instructor configured to sequentially output turn-on instruction signals to the plurality of light emitting elements to sequentially turn ON the plurality of light emitting elements;
a turn-on potential applier configured to apply a turn-on potential for turning ON the plurality of light emitting elements; and
a switching circuit configured to switch connection states between second ends of the plurality of resistance elements and the turn-on potential applier; and
a light exposure amount controller configured to control a light exposure amount for an image carrier by controlling an ON period and an emitted light intensity of the plurality of light emitting elements when forming an electrostatic latent image by exposing the image carrier to light from the light emitting device;
a developing device configured to develop the electrostatic latent image on the image carrier that has been exposed to the light by the exposing device; and
a transferrer configured to transfer, onto a recording medium, an image on the image carrier that has been developed by the developing device.
